(19) United States
(12) Patent Application Publication
(10) Pub. No.: US 2013/0069281 A1
(43) Pub. Date: Mar. 21, 2013

(54) DEVICE FOR MANUFACTURING A COMPOSITE PART BY RESIN INJECTION MOULDING

(71) Applicants: Societe Lorraine De Construction Aeronautique, Florange (FR); Arts & Metiers Paris Tech, Metz (FR); Pole de Plasturgie de L'est, Saint Avold (FR); Ateliers Cini, Tomblaine (FR)

(72) Inventors: Hervé Hurlin, Igny (FR); Patrick Martin, Villers-les-Nancy (FR); Florence Castagnet, Velizy-Villacoublay (FR); Alain D'Acunto, Saint Barbe (FR); Marius Mihaluta, Metz (FR); François Perrin, Pontoy (FR); Louis Bettega, Boucheporn (FR); Jean-Pierre Cauchois, Obersteinbach (FR); Jérome Cini, Laitre s/s Amance (FR); Richard Mangenot, Battigny (FR)

(73) Assignees: Societe Lorraine De Construction Aeronautique, Florange (FR); Ateliers Cini, Tomblaine (FR); Pole De Plasturgie De L'Est, Saint Avold (FR); Arts & Metiers Paris Tech, Metz (FR)

(21) Appl. No.: 13/674,801

(22) Filed: Nov. 12, 2012

Related U.S. Application Data
(63) Continuation of application No. PCT/FR2011/050961, filed on Apr. 28, 2011.

(30) Foreign Application Priority Data
May 10, 2010 (FR) 10/53615

(51) Int. Cl. B29C 45/04; B29C 45/00

(52) U.S. Cl. CPC B29C 45/04; B29C 45/00
USPC 264/328.1; 425/542

(57) ABSTRACT

A device for manufacturing a part in composite material by resin transfer moulding and method is provided according to the present disclosure. The device includes a manufacturing mould in which at least one preform is intended to be arranged of the part intended to be impregnated with resin during a resin transfer process. The mould is subdivided into a die and at least one movable structural element intended to be indexed on the die to form an assembly, the assembly forming a cavity corresponding to a shape of the part to be manufactured. The mould is associated with at least one positioning frame having a low coefficient of thermal expansion in at least one dimension, the positioning frame being designed to allow the indexing and holding in position of the at least one movable structural element, corresponding to at least one singularity, on the die.

### CROSS-REFERENCE TO RELATED APPLICATIONS

This application is a continuation of International Application No. PCT/FR2011/050961 filed on Apr. 28, 2011, which claims the benefit of FR 10/53615, filed on May 10, 2010. The disclosures of the above applications are incorporated herein by reference.

### FIELD

The present disclosure pertains to a device for manufacturing parts in composite material by resin transfer moulding, and also to a method for implementing the said device.

### BACKGROUND

The statements in this section merely provide background information related to the present disclosure and may not constitute prior art.

Several known moulding methods by fibre impregnation with resin can be used to manufacture parts in composite material, and in particular moulding methods using closed moulds.

First, the Resin Transfer Moulding process can be cited.

With the RTM process, a pack of fibrous elements is positioned in particular manner around a support and the whole is placed inside a closed mould, whose general shape corresponds to the shape of the part to be manufactured.

With the conventional RTM process this mould is formed of a lower female mould or die and an upper mould or punch.

A resin is then injected into the mould and it is polymerized using a supply of energy. The molecules of this resin then start to bind together and to form a solid network. This gives a rigid part in composite material formed of fibres and polymerized resin.

The moulding process by resin infusion can also be cited.

In general, said process entails several steps amongst which the laying of fibrous reinforcement elements on a mould form.

The mould is then closed via a flexible cover allowing the controlled passing of a resin which infuses inside the fibrous reinforcement elements and is then polymerized to yield a rigid part.

The propagation of the resin is obtained by a driving force created by a vacuum at some points of the cover, the resin added to the mould moving towards these points.

In the conventional infusion process, the tooling of the mould is therefore formed of a lower die cavity and an impervious cover such as a film as upper mould part.

These processes whether standard RTM or resin infusion moulding, are technologies in which the moulding tooling is cumbersome and designed for a specific shape of part intended to be manufactured. This generates high tooling costs in order to be able to produce a wide variety of parts.

In addition, this tooling may have a much limited lifetime. It will be understood that with standard RTM tooling, the deterioration of the die cavity or of the upper mould, or of both, implies the deterioration of the tooling thus formed as a whole.

Finally, on account of the complex development of moulding adapted to a specific type of part in composite material, these technologies are limited to shapes of parts in composite material that are moderately or scarcely complex having fairly simple characteristics.

Patent application FR 09/00300, not yet published, provides a device allowing an improvement in the manufacture of composite parts and meeting the above-mentioned disadvantages.

However, some difficulties remain for the manufacture of parts in composite materials using these infusion techniques.

One major difficulty is the heed which must be paid to the positioning of regions having singularities such as reinforcements, sandwiching, inserts for example, in particular for precision parts manufactured inter alia for aeronautic applications.

These singularities in composite parts are positioned in particular to improve the transferring of forces within the part and its mechanical strength. Their precise positioning is therefore important.

### SUMMARY

The present disclosure consists of a device for manufacturing a part in composite material by resin transfer moulding which comprises a manufacturing mould in which at least one preform is intended to be arranged that is to be impregnated with resin during the resin transfer process, the mould being subdivided into a die and one or more movable structural elements intended to be indexed on the die, the assembly after assembling forming a cavity corresponding to the shape of the part to be manufactured, characterized in that the mould is associated with at least one positioning frame having a low coefficient of thermal expansion in at least one dimension, or any coefficient of expansion but which is anticipated on the positioning frame and/or on the polymerization cycle, or any coefficient of expansion if the positioning frame is thermally insulated, the positioning frame being designed so as to allow the indexing and holding in position of one or more movable structural elements, corresponding to at least one singularity, on the die.

Therefore by providing for the association of a positioning frame having a low coefficient of linear expansion in one or more dimensions as applicable, and more generally for expansion deformations that are stable or controlled, it is possible to retain in a precise position all the elements intended for the moulding of the special features (reinforcements, sandwiching, etc.) of the composite part.

The positioning frame may also be formed of a material whose thermal behaviour (expansion) is sufficiently predictable to be taken into account e.g. aluminum. However, the differential in thermal expansion coefficients may lead to non-negligible stress transfers. The risks entailed range from deformation of the part, mould release difficulties to impairment of the health of the material (e.g., delamination, micro-cracking of the resin).

The positioning frame may also be made of a material having any thermal behaviour provided it is thermally insulated from the remainder of the tooling. The rise in temperature required for polymerization of the resin will not induce any displacement of the elements of the positioning frame. In this case, the expansion of the composite part is negligible compared with the desired positioning tolerances.

With this approach it is possible obtain parts using basic tooling, in particular a low-cost die, only those elements requiring precise positioning being made in technically more costly materials, or in low-cost technical materials if the positioning frame is thermally insulated.

Advantageously, the positioning frame has a very low coefficient of heat expansion in the three dimensions in space.

Preferably, the holding in position of the structural elements is obtained at least partly by pressure means equipping the positioning frame, or via a degree of freedom perpendicular to the composite part. Further preferably, the pressure means are located at a positioning index of the corresponding structural element.

Ideally, this pressure mechanism guarantees a constant compacting pressure despite the reduction in thickness of the preform (dry fibres).

In one form, the die is made of aluminum.

Advantageously, the positioning frame is equipped with at least one supporting indexation foot.

According to one variant of present disclosure, the die is of planar shape.

In one form, the dismountable structural elements are independent, three-dimensional geometric blocks whose shape and dimensions are adapted to the shape and dimensions of the part to be manufactured.

Advantageously, the device comprises at least one resin injecting means.

In addition, the device may also comprise the following options:
the dismountable structural elements may include flexible or rigid cores of any type whose shape and dimensions are adapted for hollow structures;
the structural elements are capable of ensuring a venting role;
the device comprises injection means adapted to achieve simultaneous or sequential impregnation of the preform with the injected resin;
the injection means are distributed over the surface of the mould so that they promote the transversal and/or laminar diffusion of the resin;
the device further comprises a system for sealing the structural elements against the resin injected into the manufacturing mould.

The present disclosure also relates to a method for implementing a device to manufacture a part in composite material via resin injection moulding according to the invention, characterized in that it comprises the steps of:
indexing one or more movable structural elements of the mould on the die by means of the positioning frame so that the assembly, after assembling, forms a cavity corresponding to the shape of the part to be manufactured;
applying a force to hold in position and compact the structural elements indexed by means of the said positioning frame;
preforming the part, in particular the dry fibres;
moulding the part by resin injection.

Advantageously, transversal impregnation is performed relative to the plane of the preform and/or laminar impregnation relative to this plane of the preform.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

Other features, aims and advantages of the present disclosure will appear upon reading the following detailed description, according to the embodiments provided as non-limiting examples, and in reference to the appended drawing, in which:

FIG. 1 is a schematic cross-sectional illustration of a device according to the present disclosure.

The drawing described herein is for illustration purposes only and is not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

The general principle of the modular device comprising a die and movable structural elements indexed on the die can be found in application FR 09/00300.

In substance, the manufacture of a part in composite material essentially comprises the moulding, by means of an adapted manufacturing device, of a composite element by injection of liquid resin into a framework of essentially dry reinforcement fibres previously pre-formed in accordance with the shape of the profile of the part and pre-arranged in a closed mould.

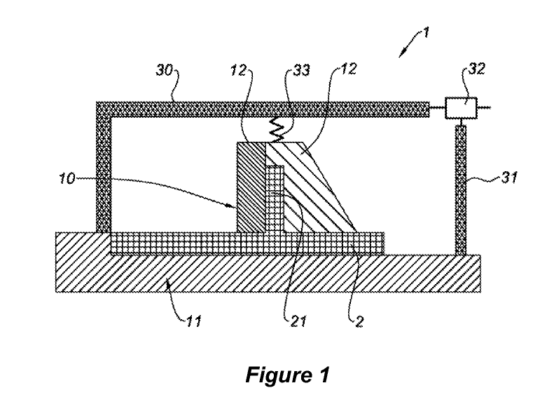

Said moulding device 1 is schematically illustrated in the single FIG. 1.

This device 1 comprises a mould 10 defining a moulding cavity intended to receive a preform 2 able to be impregnated with resin to form the part in composite material.

The mould 10 is sub-divided into a moulding die 11 on which one or more moulding structural elements 12 are placed and indexed, that are independent and mobile so that the assembly, after assembling, forms a cavity corresponding to the shape of the profile of the part to be designed.

The moulding die 11 here, solely as an example, is planar.

The structural elements 12 are able to be moved on the moulding die 11 in relation to the shape of the parts to be formed. They are three-dimensional geometric blocks whose shape, dimensions, thickness and positioning on the die 11 are adapted to the shape of the profile of the part to be manufactured. They therefore pay heed to the geometric, dimensional and thickness constraints of the part.

These structural elements particularly allow singularities to be obtained, such as reinforcements 21 for example, and the positioning thereof in relation to each part to be formed.

In practice, to impregnate the preform 1 with the resin, the mould 10 is connected to a resin container (not illustrated) itself placed inside heating means (not illustrated) such as an oven or any other suitable heating means. The container is connected to the mould 10 via resin injection means.

In addition, the mould 10 may be associated with a cover intended to close the mould 10 and ensure the role of a mating mould part.

The mould 10 is also equipped with peripheral seals ensuring a seal between the cover and the mould 10, the assembly thereby forming a sealed volume materializing the volume of the part to be manufactured.

According to the present disclosure, and to hold the structural elements 12 precisely in position throughout the resin injection phase, the device 1 also comprises a positioning frame 30 held in place by means of an indexing foot 31 via a connection 32 between the said frame 30 and the foot 31.

Also according to the present disclosure, this positioning frame has a low coefficient of thermal expansion in the axis of the die 11, or any coefficient of expansion if its expansion is predictable and the applied temperature cycle is adapted thereto, or any coefficient of expansion if the positioning frame is thermally insulated and hence does not expand.

The positioning frame 30 also has elastic pressure means 33 (e.g. a spring) capable of applying pressure to the structural elements 12 to hold them in position. The compacting pressure may also result from the vacuum present in the mating part of the mould. The positioning elements in this case have a degree of freedom in the direction perpendicular to the composite part.

The preforming and compacting operation of the dry fibres allows a substantial volume percentage to be obtained. A binder can be used to fix the volume of fibres obtained. In this case, a polymerization cycle of the binder is applied during the preforming operation. This tooling design allows the preforming and moulding operations to be carried out using the same tooling.

Therefore by means of the positioning frame, the structural elements 12 can be positioned precisely and held in position independently of any deformation by expansion of the die 11.

Although the invention has been described with a particular example of embodiment, it is evidently in no way limited thereto and comprises all technical equivalents of the described means and the combinations thereof if they come within the scope of the invention.

What is claimed is:

1. A device for manufacturing a part in composite material by resin transfer moulding, comprising a manufacturing mould in which at least one preform is intended to be arranged of the part intended to be impregnated with resin during a resin transfer process, the mould being subdivided into a die and at least one movable structural element intended to be indexed on the die to form an assembly, the assembly forming a cavity corresponding to a shape of the part to be manufactured, characterized in that the mould is associated with at least one positioning frame having a low coefficient of thermal expansion in at least one dimension, the positioning frame being designed to allow the indexing and holding in position of the at least one movable structural element, corresponding to at least one singularity, on the die.

2. The device according to claim 1, characterized in that the positioning frame has a low coefficient of thermal expansion in three dimensions.

3. The device according to claim 1, characterized in that the holding in position of the structural elements is obtained at least in part by at least one of a pressure means equipping the positioning frame and via a degree of freedom perpendicular to the composite part.

4. The device according to claim 3, characterized in that the pressure means are located at a positioning index of the corresponding structural element.

5. The device according to claim 1, characterized in that the die is made of aluminum.

6. The device according to claim 1, characterized in that the positioning frame is equipped with at least one supporting indexation foot.

7. The device according to claim 1, characterized in that the die is a planar shape.

8. The device according to claim 1, characterized in that the structural elements are independent, three-dimensional geometric blocks that define a shape and dimensions that are adapted to the shape and dimensions of the part to be manufactured.

9. The device according to claim 1, characterized in that it comprises at least one resin injection means.

10. A method for implementing a device to manufacture a part in composite material by resin injection moulding according to claim 1, characterized in that it comprises the steps of:
indexing one or more movable structural elements of the mould on the die of the mould by means of the positioning frame so that the assembly, after assembling, forms a cavity corresponding to the shape of the part to be manufactured,
applying a force to hold in position and compact the structural elements indexed by means of the said positioning frame;
preforming the part; and
moulding the part by resin injection.
